(19) United States
(12) Patent Application Publication
(10) Pub. No.: US 2025/0290830 A1
(43) Pub. Date: Sep. 18, 2025

(54) Integrated Product Testing Method and Device Combining Accelerated Life Test and Accelerated Degradation Test

(71) Applicant: CHINA ELECTRONIC PRODUCT RELIABILITY AND ENVIRONMENTAL TESTING RESEARCH INSTITUTE, Guangzhou (CN)

(72) Inventors: Guangze PAN, Guangzhou (CN); Qian LI, Guangzhou (CN); Xiaobing LI, Guangzhou (CN); Baimao LEI, Guangzhou (CN); Xianghong HU, Guangzhou (CN); Debin CHENG, Guangzhou (CN); Qin LUO, Guangzhou (CN); Zigang CAI, Guangzhou (CN); Dan LI, Guangzhou (CN); Fangfei LIU, Guangzhou (CN); Guoqing WANG, Guangzhou (CN)

(21) Appl. No.: 19/082,630

(22) Filed: Mar. 18, 2025

(30) Foreign Application Priority Data
Mar. 18, 2024 (CN) 202410305623.3

(51) Int. Cl. G01M 13/04

(52) U.S. Cl. CPC G01M 13/04

(57) ABSTRACT

The present disclosure relates to a product testing method and apparatus integrating accelerated life test and accelerated degradation test, computer device, storage medium and computer program product. The method includes, performing failure mode analysis on components of a product to be evaluated, classifying the components into sudden failure components and degradation failure components, performing accelerated life tests on the sudden failure components to determine a first cumulative failure probability function of each of the sudden failure components, performing accelerated degradation tests on the degradation failure components to determine a second cumulative failure probability function of each of the degradation failure components, and determining a reliability of the product to be evaluated based on the first cumulative failure probability function and the second cumulative failure probability function.

### CROSS-REFERENCE TO RELATED APPLICATIONS

The present application claims priority to Chinese patent application No. 2024103056233, filed on Mar. 18, 2024, the entire content of which is incorporated herein by reference.

### TECHNICAL FIELD

The present disclosure relates to the field of product reliability testing technologies, and in particular, to an integrated product testing method and apparatus combining accelerated life test and accelerated degradation test, computer device, storage medium and computer program product.

### BACKGROUND

With the development of the times, the competition environment in all walks of life is becoming increasingly fierce. In order to put products that meet the expected reliability requirements into use as quickly as possible, operators usually need to quickly test the reliability indicators of products, such as performing accelerated reliability tests on products.

In conventional technology, operators usually apply stresses higher than normal use conditions to a product without changing the product failure mode and failure mechanism, thereby accelerating the failure or performance degradation process of the product. By performing statistical analysis on the data obtained under accelerated stress, a rapid test of product reliability can be achieved.

### SUMMARY

In a first aspect, an integrated product testing method combining accelerated life test and accelerated degradation test is provided in the present disclosure. The method is applied to a testing system. The testing system includes a server and a testing terminal. The testing terminal includes a plurality of test boxes, each of which is configured to perform an accelerated life test or an accelerated degradation test on a component of a product to be evaluated when components of the product to be evaluated are placed in the plurality of test boxes respectively and interconnected. The method includes:
performing failure mode analysis on components of a product to be evaluated, and classifying the components into sudden failure components and degradation failure components;
for different sudden failure components, performing accelerated life tests on the sudden failure components by using different first preset accelerated stresses to determine failure times of the sudden failure components, determining first cumulative failure probabilities of the sudden failure components based on the failure times, and determining a first cumulative failure probability function of each of the sudden failure components based on the first cumulative failure probabilities and preset first cumulative failure probability distribution data;
for different degradation failure components, performing accelerated degradation tests on the degradation failure components by using different second preset accelerated stresses to determine failure thresholds of the degradation failure components, obtaining performance parameters of each of the degradation failure components at different preset moments to obtain performance parameter set corresponding to each of the degradation failure components, and determining a second cumulative failure probability function of each of the degradation failure components based on the performance parameter set corresponding to each of the degradation failure components, the failure thresholds and preset second cumulative failure probability distribution data; and
determining first failure times of the sudden failure components under a normal stress based on the first cumulative failure probability function and a first preset acceleration coefficient, determining second failure times of the degradation failure components under a normal stress based on the second cumulative failure probability function and a second preset acceleration coefficient, determining a target failure time of the product to be evaluated under a normal stress based on the first failure times and the second failure times, and determining a reliability of the product to be evaluated based on the target failure time.

In an embodiment, determining the first cumulative failure probabilities of the sudden failure components based on the failure times includes:
sorting the failure times to obtain a sorting result; and
determining the first cumulative failure probabilities of the sudden failure components based on positions of the failure times in the sorting result.

In an embodiment, after determining the target failure time of the product to be evaluated under the normal stress based on the first failure times and the second failure times, the method further includes:
on a condition that there are a plurality of the products to be evaluated, fitting the target failure times based on preset failure probability distribution data to obtain a cumulative failure probability function of the products to be evaluated;
determining a mean time between failures of the products to be evaluated based on the cumulative failure probability function; and
determining the reliability of the products to be evaluated based on the mean time between failures.

In an embodiment, the preset first cumulative failure probability distribution data comprise a Weibull distribution function, an exponential distribution function, or a log-normal distribution function. The preset second cumulative failure probability distribution data comprise a standard normal distribution function.

In a second aspect, an integrated product testing apparatus combining accelerated

life test and accelerated degradation test is further provided in the present disclosure. The apparatus includes:
a mode analysis module configured to perform failure mode analysis on components of the product to be evaluated, and classify the components into sudden failure components and degradation failure components;
a first test module configured to perform accelerated life tests on the sudden failure components by using different first preset accelerated stresses for different sudden failure components, to determine failure times of the sudden failure components, determine first cumulative failure probabilities of the sudden failure components based on the failure times, and determine a first cumulative failure probability function of each of the sudden failure components based on the first cumulative failure probabilities and preset first cumulative failure probability distribution data;
a second test module configured to perform accelerated degradation tests on the degradation failure components by using different second preset accelerated stresses for different degradation failure components, to determine failure thresholds of the degradation failure components, obtain performance parameters of each of the degradation failure components at different preset moments to obtain performance parameter set corresponding to each of the degradation failure components, and determine a second cumulative failure probability function of each of the degradation failure components based on the performance parameter set corresponding to each of the degradation failure components, the failure thresholds and the preset second cumulative failure probability distribution data; and
a product evaluation module configured to determine first failure times of the sudden failure components under a normal stress based on the first cumulative failure probability function and a first preset acceleration coefficient, determine second failure times of the degradation failure components under a normal stress based on the second cumulative failure probability function and a second preset acceleration coefficient, determine a target failure time of the product to be evaluated under a normal stress based on the first failure times and the second failure times, and determine a reliability of the product to be evaluated based on the target failure time.

In a third aspect, a computer device is further provided in the present disclosure. The computer device includes a memory and a processor, the memory stores a computer program, and the processor, when executing the computer program, implements the steps of the integrated product testing method combining accelerated life test and accelerated degradation test in the above-mentioned embodiment.

In a fourth aspect, a non-transitory computer-readable storage medium is further provided in the present disclosure. The computer-readable storage medium stores a computer program thereon. A processor, when executing the computer program, implements the steps of the integrated product testing method combining accelerated life test and accelerated degradation test in the above-mentioned embodiment.

In a fifth aspect, a computer program product is further provided in the present disclosure. The computer program product includes a computer program. A processor, when executing the computer program, implements the steps of the integrated product testing method combining accelerated life test and accelerated degradation test in the above-mentioned embodiment.

### BRIEF DESCRIPTION OF THE DRAWINGS

FIG. 1 is a schematic diagram of an application environment of a product testing method integrating accelerated life test and accelerated degradation test in an embodiment.

FIG. 2 is a schematic flowchart of a product testing method integrating accelerated life test and accelerated degradation test in an embodiment.

FIG. 3 is a schematic flowchart of determining a first cumulative failure probability function in an embodiment.

FIG. 4 is a schematic flowchart of determining a first cumulative failure probability function in another embodiment.

FIG. 5 is a schematic flowchart of determining a second cumulative failure probability function in an embodiment.

FIG. 6 is a schematic flowchart of determining a second cumulative failure probability function in another embodiment.

FIG. 7 is a schematic flowchart of a product testing method integrating accelerated life test and accelerated degradation test in a detailed embodiment.

FIG. 8 is a block diagram of a product testing apparatus integrating accelerated life test and accelerated degradation test in an embodiment.

FIG. 9 is a block diagram of a structure of a product testing apparatus integrating accelerated life test and accelerated degradation test in another embodiment.

FIG. 10 is a schematic diagram of an internal configuration of a computer device in an embodiment.

### DETAILED DESCRIPTION OF THE EMBODIMENTS

To make the purposes, features, and advantages of the present disclosure more clearly understood, detailed explanations of specific embodiments of the present disclosure are provided below in conjunction with the accompanying drawings. It should be understood that the specific embodiments described herein are only used to explain the present disclosure and are not used to limit the present disclosure.

In conventional technology, operators usually apply stresses higher than normal use conditions to a product without changing the product failure mode and failure mechanism, thereby accelerating the failure or performance degradation process of the product. By performing statistical analysis on the data obtained under accelerated stress, a rapid test of product reliability can be achieved.

However, the above-mentioned conventional reliability accelerated test is usually only applicable to products with simple component composition. When faced with products with complex component composition, the types and magnitudes of influencing stresses of different components may be different, resulting in low accuracy of reliability test results.

In view of this, a product testing method is provided in the present disclosure.

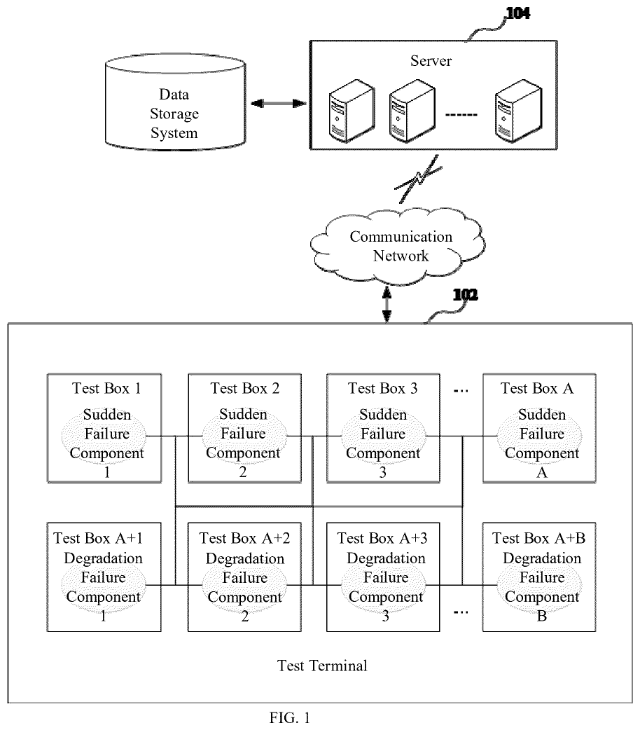

A product testing method integrating accelerated life test and accelerated degradation test provided in embodiments of the present disclosure can be applied in the application environment as shown in FIG. 1. The application environment is also called a testing system, in the system, a test terminal 102 communicates with a server 104 via a communication network. A data storage system can store data that the server 104 needs to process. The data storage system can be integrated on the server 104 or can be located in the cloud or other network servers.

The test terminal 102 includes a plurality of test boxes 1021, each test box 1021 is configured to perform accelerated life test or accelerated degradation test a component of a product to be tested according to the instructions from the server 104. In some embodiments, a product to be tested may also be called a product to be evaluated.

In some embodiments, the server 104 can obtain information of components of a product to be tested, perform failure mode analysis on the components of the product to be tested, and classify the components into sudden failure components and degradation failure components. Then, the sudden failure components and the degradation failure components are placed in different test boxes 1021 of the test terminal 102, respectively, and the different components are connected by wiring. The server 104 controls the respective test boxes 1021 to perform accelerated tests on the components placed therein at the same time. Accelerated life tests are performed on the sudden failure components, and accelerated degradation tests are performed on the degradation failure components. For example, the server 104 receives information about a product P input by the user, including components P1, P2, and P3, and determines that P1 is a sudden failure component, while P2 and P3 are degradation failure components. Therefore, the server 104 outputs a message prompting the user to place P1 into the test box B1, place P2 into the test box B2, and place P3 into the test box B3. Then, the server 104 controls the test boxes B1 to B3 to apply corresponding stresses to P1 to P3 based on a preset relationship between components and stresses. In this way, through the isolation of the test boxes, different accelerated stresses can be applied to the components in different test boxes, thereby reducing the effects of non-influencing stresses on the components, reducing the possibility of changes in the failure mode and failure mechanism of the components, and making the reliability test results more accurate. The server 104 obtains the accelerated test result of each test box, and determines the first cumulative failure probability function of each sudden failure component and the second cumulative failure probability function of each degradation failure components in the test results, and the server 104 determines the reliability of the product to be test based on the first cumulative failure probability function and the second cumulative failure probability function. The server 104 can be an independent server or a server cluster including multiple servers.

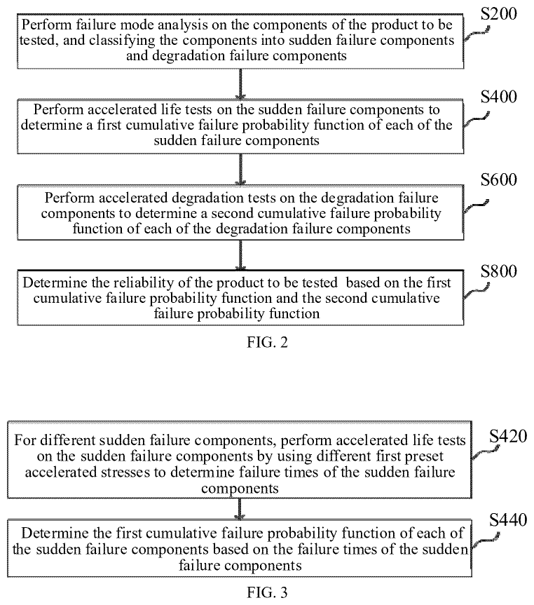

In an embodiment, as shown in FIG. 2, a product testing method integrating accelerated life test and accelerated degradation test is provided. The method applied to the server 104 in FIG. 1 as an example for description, includes the following steps S200 to S800.

In S200, failure mode analysis is performed on the components of the product to be tested, and the components are classified into sudden failure components and degradation failure components.

The products to be tested may include but are not limited to mechanical equipment or electronic products, such as desktop computers or generators. Failure modes include sudden failure mode and degradation failure mode. Sudden failure mode means that the product fails suddenly under certain conditions, and a failure time is unpredictable, such as a sudden short circuit in a circuit board. Degradation failure mode means that the product gradually degrades or is damaged during use, eventually leading to failure, such as a decrease in transmission efficiency of mechanical components due to wear.

Accordingly, based on the above definition of the failure modes, the components of the product to be tested can be classified into sudden failure components and degradation failure components. The failure mode of sudden failure components is the sudden failure mode, and the failure mode of degradation failure components is the degradation failure mode.

In S400, accelerated life tests are performed on the sudden failure components by using the test boxes to determine a first cumulative failure probability function of each of the sudden failure components.

The accelerated life tests are test methods that accelerate the product failure by simulating the operation of the product under high stress in a relatively short period of time. The cumulative failure probability can be configured to describe the probability of a product or system failing after running for a period of time. In this embodiment, the first cumulative failure probability function is configured to describe the probability of a sudden failure component failing after running for a period of time.

Following the above steps, after the components of the product to be tested are classified into the sudden failure components and the degradation failure components, different components can be placed in different test boxes, and accelerated stresses of corresponding types and values can be applied. The test boxes are connected by wiring so that the components of the product to be tested are still interconnected, thereby supporting the normal operation of the product to be tested during the tests.

Sudden failure components usually fail suddenly under specific conditions, and their reliability can be measured using the accelerated life test. Taking an electronic switch as an example, in some cases, the electronic switch may fail suddenly due to sudden damage of internal components or external interference, so the electronic switch is a kind of sudden failure component.

In some embodiments, when performing accelerated life tests on the electronic switch, the electronic switch may be placed in a test box, but it still needs to remain connected to an external circuit. A working stress limit of the electronic switch used in the test can be determined by the design specification or design manual of the electronic switch, and the working stress limit is used as the acceleration stress value of the electronic switch. By applying corresponding accelerated stress by the test box, external interference or internal component failure can be simulated to trigger the failure of the electronic switch. According to a series of failure performances and failure parameters of the electronic switch in the accelerated life tests, the first cumulative failure probability function of the electronic switch can be determined accordingly to evaluate its reliability.

In S600, accelerated degradation tests are performed on the degradation failure components by using the test boxes to determine a second cumulative failure probability function of each of the degradation failure components.

The accelerated degradation tests are test methods that accelerate the product's performance degradation process by simulating the operation of the product under high stress in a relatively short period of time. In this embodiment, the second cumulative failure probability function may be configured to describe the probability of a degradation failure component failing after running for a period of time.

The degradation failure components usually fail gradually over time or with increasing usage. The cause of failure is usually aging, wear or deformation of internal materials. Taking a mechanical bearing as an example, since mechanical bearing will be subject to friction and wear during long-term operation, the surface quality of their internal parts will gradually decrease, eventually leading to the failure of the mechanical bearing. Therefore, mechanical bearing is a kind of degenerate failure component and accelerated degradation tests can be performed on the mechanical bearing.

In some embodiments, the mechanical bearing can be placed in the test box, but still needs to be connected to other components in the product to be tested so that the mechanical bearing can still function normally during the accelerated degradation tests. A working stress limit of the mechanical bearing used in the test can be determined by the design specification or design manual of the mechanical bearing, and the working stress limit is used as the acceleration stress value of the mechanical bearing. For example, during the accelerated degradation test, the load or rotation speed of the mechanical bearing may be increased, or the temperature or humidity of the test environment may be increased to accelerate the degradation of the mechanical bearing. Based on a series of degradation performances and degradation parameters of the mechanical bearing during the test, the second cumulative failure probability function of the mechanical bearing may be determined accordingly to evaluate its reliability.

In S800, the reliability of the product to be tested is determined based on the first cumulative failure probability function and the second cumulative failure probability function.

Following the above steps, the cumulative failure probability function corresponding to each of the components in the product to be tested can be obtained. Further, the reliability of each of the components can be determined based on the cumulative failure probability function, and then the reliability of the product to be tested can be determined.

For example, based on the cumulative failure probability function of the component, the failure condition of the corresponding component at a specific time point or time period can be determined, and the failure condition can be configured to determine the reliability of the component. Furthermore, the reliability of the product to be tested can be determined based on the reliability of the components, for example, based on a weighted average of the reliability index of the components, or based on the reliability index of the component with the lowest reliability.

The above-mentioned product testing method integrating accelerated life test and accelerated degradation test, before placing the components of the product to be tested into the test boxes, a failure mode analysis is first performed on the components of the product to be tested, thereby classifying the components of the product to be tested into sudden failure components and degradation failure components. Then, accelerated life tests are performed on the sudden failure components to determine a first cumulative failure probability function of each of the sudden failure components, and accelerated degradation tests are performed on the degradation failure components to determine a second cumulative failure probability function of each of the degradation failure components. Finally, the reliability of the product to be tested is determined based on the first cumulative failure probability function and the second cumulative failure probability function. Unlike conventional reliability evaluation method, the method provided in the present application employs different accelerated tests for different components of the product to be tested. Accelerated life tests are used to test the reliability of the sudden failure components, and accelerated degradation tests are used to test the reliability of the degradation failure components. The reliability test results of the above two types of components are integrated to conduct a comprehensive reliability test of the entire product to be tested, thereby improving the accuracy of the reliability test results of the product to be tested.

In an embodiment, there are a plurality of sudden failure components. As shown in FIG. 3, S400 includes the following steps S420 to S440.

In S420, for different sudden failure components, accelerated life tests are performed on the sudden failure components by using different first preset accelerated stresses to determine failure times of the sudden failure components.

In S440, the first cumulative failure probability function of each of the sudden failure components is determined based on the failure times of the sudden failure components.

In some embodiments, taking the product to be tested is a servo system of a certain model as an example, in the servo system, the servo driver is a sudden failure component, so an accelerated life test is performed on the servo driver.

Exemplarily, the acceleration stress type of the servo driver is temperature, and according to the design specification or design manual, the acceleration stress value of the servo driver is 60 degrees Celsius, so the first preset acceleration stress for the servo driver is a temperature of 60 degrees Celsius. The servo driver is placed in a test box, and the first preset acceleration stress is applied to the servo driver by the test box until the servo driver fails, and the failure time is recorded.

Furthermore, in addition to the servo driver, the servo system may also include other sudden failure components. Each of the sudden failure components is placed in a separate test box and the corresponding first preset acceleration stress is applied until the sudden failure component fails, and the failure time is recorded.

According to the above method, the failure times of a plurality of sudden failure components in the servo system can be obtained. Based on the plurality of failure times, the cumulative failure probability of each of the sudden failure components can be determined. For example, the first cumulative failure probability function of each of the sudden failure components can be constructed. The first cumulative failure probability function can represent the failure probability of each of the failure components at a specific time point or within a specific time period.

In this embodiment, different first preset accelerated stresses are applied to the plurality of different sudden failure components in the product to be tested, and accelerated life tests are performed to determine the failure times of the sudden failure components. Based on the failure times, the first cumulative failure probability function of each of the sudden failure components is determined to determine the reliability of the product. Through the above method, the accelerated life tests are applied to the sudden failure components, which can obtain a more accurate reliability evaluation result, thereby making the reliability evaluation result of the product to be tested more reliable.

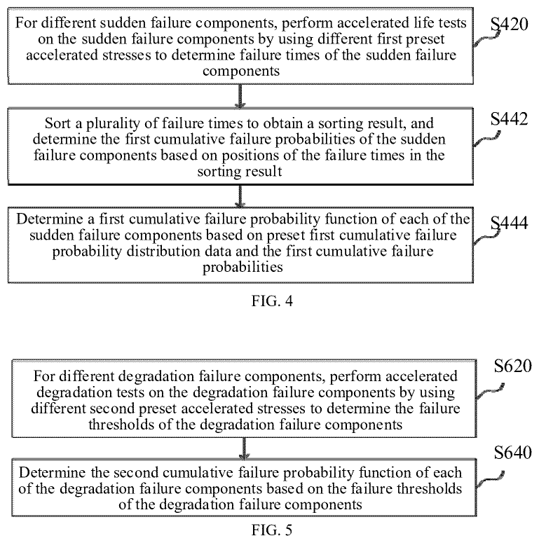

In an embodiment, the first cumulative failure probability function for each sudden failure component is determined based on the failure times of the identical sudden failure components of a plurality of products to be tested. As shown in FIG. 4, determining the first cumulative failure probability function of each of the sudden failure components based on the failure times of the sudden failure components includes steps S442 to S444.

In S442, a plurality of failure times are sorted to obtain a sorting result, and the first cumulative failure probabilities of the sudden failure components are determined based on positions of the failure times in the sorting result.

In this embodiment, the plurality of failure times are obtained by performing accelerated tests on the identical sudden failure components in a plurality of products to be tested. For example, a plurality of failure times of servo drivers are obtained by performing accelerated tests on the servo drivers in a plurality of servo systems to be tested, and accordingly, the corresponding first cumulative failure probability for each servo driver is determined based on the sorting result of the failure times of the plurality of servo drivers.

In S444, a first cumulative failure probability function of the sudden failure component is determined based on preset first cumulative failure probability distribution data and the first cumulative failure probabilities.

The first cumulative failure probability distribution data refers to a distribution function configured to fit the first cumulative failure probabilities of the sudden failure components, such as a Weibull distribution function, an exponential distribution function, and a log-normal distribution function.

According to the same method, the first cumulative failure probability function of each sudden failure component can be determined.

Following the above embodiment, taking m servo systems including m sudden failure components A as an example, after the failure times of the m sudden failure components are obtained by the method in the above embodiment, the plurality of failure times can be sorted from small to large, as shown in formula (1):

$${t}_{A 1} < {t}_{A 2} < … < {t}_{Ai} < … < {t}_{Am} \qquad ( 1 )$$

In formula (1), the corresponding serial numbers of the failure times are 1, 2, . . . , i, . . . , m respectively, where i=1,2, . . . , m. Accordingly, the first cumulative failure probability F(t_{Ai}) of each sudden failure component can be expressed by formula (2)

$$F ( {t}_{Ai} ) = \frac{i}{m + 1} \qquad ( 2 )$$

It can be understood that the failure times of the sudden failure components A are: t_{A1}, t_{A2}, . . . , t_{Ai} . . . , t_{Am}. The corresponding first cumulative failure probabilities are:

F(t_{A1}), F(t_{A2}), . . . , F(t_{Ai}), . . . , F(t_{Am}).

Furthermore, taking the first cumulative failure probability distribution data as a Weibull distribution function as an example, it can be expressed as formula (3):

$$F ( t ) = 1 - exp [ - {( \frac{t}{α} )}^{β} ] . \qquad ( 3 )$$

In formula (3), α and β represent the unknown parameters in the first cumulative failure probability distribution data, and t represents the failure time of the sudden failure component.

After the first cumulative failure probability distribution data and the first cumulative failure probabilities of the sudden failure components are determined, the unknown parameters in formula (3) can be further calculated, and finally the first cumulative failure probability function of each of the sudden failure components can be obtained. Specifically, let x=ln t, then formula (3) is transformed into formula (4):

$$F ( x ) = 1 - exp [ - exp ( \frac{x - υ}{τ} ) ] . \qquad ( 4 )$$

In formula (4),

$$τ = \frac{1}{β} ,$$

and ν=ln α. Estimated values of parameters ν and τ are calculated first, and then α and β are solved for. The parameter solving process is as follows:

Let

$$y - \frac{x - υ}{τ} ,$$

then formula (4) is transformed into formula (5):

$$F ( y ) = 1 - exp [ - exp ( y ) ] . \qquad ( 5 )$$

According to formulas (4) and (5), the estimated values of ν and τ can be expressed by formulas (6) and (7):

$$\hat{υ} = {\sum }_{i = 1}^{m} D ( m , m , i ) {x}_{Ai} \qquad ( 6 )$$

$$\hat{τ} = {\sum }_{i = 1}^{m} C ( m , m , i ) {x}_{Ai} \qquad ( 7 )$$

The estimated value of β can be expressed by formula (8):

$${\hat{β}}^{′} = \frac{1}{\hat{τ}} = \frac{1}{{\sum }_{i = 1}^{m} C ( m , m , i ) {x}_{Ai}} . \qquad ( 8 )$$

It should be noted that, after statistics of engineering experience, the estimated value in formula (8) is a value to be corrected, and the correction coefficient g_{m,m} can be determined from a large amount of engineering experience. g_{m,m} can be obtained by looking up a mathematical statistics table. Therefore, the corrected β can be expressed by formula (9):

$$\hat{β} = \frac{{g}_{m , m}}{\hat{τ}} = \frac{{g}_{m , m}}{{\sum }_{i = 1}^{m} C ( m , m , i ) {x}_{Ai}} \qquad ( 9 )$$

The estimated value of a can be expressed by formula (10):

$$\hat{α} = exp ( \hat{υ} ) = exp ( {\sum }_{i = 1}^{m} D ( m , m , i ) {x}_{Ai} ) . \qquad ( 10 )$$

The first cumulative failure probability function of the sudden failure component is finally determined, which can be expressed by formula (11):

$$F ( t ) = 1 - exp [ - {( \frac{t}{\hat{α}} )}^{\hat{β}} ] . \qquad ( 11 )$$

According to the above method, the first cumulative failure probability functions of the sudden failure components under the first preset accelerated stress can be determined as: F_{S1}(t), F_{S2}(t), . . . , F_{SA}(t), respectively.

In this embodiment, the failure times of the sudden failure components under the first preset accelerated stress are fully considered, and the first cumulative failure probabilities of the sudden failure components are determined. Combined with the Weibull distribution function, the first cumulative failure probability functions of the sudden failure components are determined, which can rigorously and accurately represent the failure conditions of the sudden failure components at a specific time point or a specific time period, thereby accurately evaluating the reliability of the product.

In an embodiment, there are a plurality of the degenerate failure components. As shown in FIG. 5, S600 includes the following steps S620 to S640.

In S620, for different degradation failure components, accelerated degradation tests are performed on the degradation failure components by using different second preset accelerated stresses to determine the failure thresholds of the degradation failure components.

In S640, the second cumulative failure probability function of each of the degradation failure components is determined based on the failure thresholds of the degradation failure components.

The failure threshold refers to a certain kind of performance parameter of the degenerate failure component at the moment of failure. For example, the operating temperature of an integrated circuit board in an electronic device usually has a threshold. When the operating temperature exceeds the threshold, the integrated circuit board will be overheated and its performance will be degraded until it cannot achieve the expected function. In other words, the threshold of the operating temperature can be the failure threshold of the integrated circuit board.

In this embodiment, taking the product to be tested is a servo system of a certain model as an example, in the servo system, the servo motor is a degenerate failure component, so an accelerated degradation test is performed on the servo motor.

Exemplarily, the acceleration stress type of the servo motor is load, and according to the design specifications or design manual, the acceleration stress value of the servo motor is 2.6 times the rated load. Therefore, the second preset acceleration stress for the servo drive is 2.6 times the rated load. The servo motor is placed in a test box, and the second preset acceleration stress is applied to the servo motor by the test box until the servo motor fails, and the failure threshold is recorded.

furthermore, in addition to the servo motor, the servo system may also include other degradation failure components. Each of the degradation failure components is placed in a separate test box and the corresponding second preset acceleration stress is applied until the degradation failure component fails, and the failure threshold is recorded.

According to the above method, the failure thresholds of a plurality of degenerate failure components in the servo system can be obtained. Based on the plurality of failure thresholds, the cumulative failure probability of each of the degenerate failure components can be determined. For example, the second cumulative failure probability function of each of the degenerate failure components can be constructed. The second cumulative failure probability function can represent the failure probability of each of the degenerate failure components at a specific time point or within a specific time period.

In this embodiment, different second preset accelerated stresses are applied to the plurality of different degradation failure components in the product to be tested, and accelerated degradation tests are performed to determine the failure thresholds of the degradation failure components. Based on the failure thresholds, the second cumulative failure probability function of each of the degradation failure components is determined to determine the reliability of the product. Through the above method, accelerated degradation tests are applied to the degradation failure components, which can obtain reliability evaluation results with higher accuracy, thereby making the reliability evaluation results of the products to be tested more reliable.

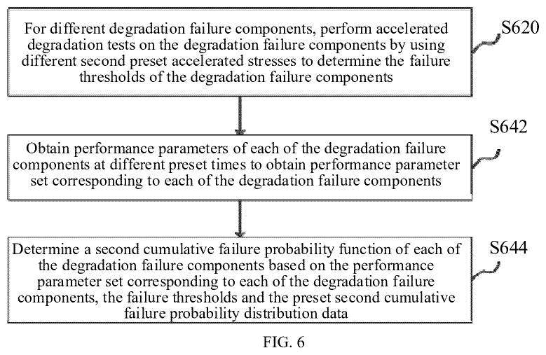

In an embodiment, the second cumulative failure probability function for each degradation failure component is determined based on the failure thresholds of the identical degradation failure components of a plurality of products to be tested. As shown in FIG. 6, S640 includes the following steps S642 to S644.

In S642, performance parameters of each of the degradation failure components at different preset times are obtained to obtain performance parameter set corresponding to each of the degradation failure components.

In S644, a second cumulative failure probability function of each of the degradation failure components is determined based on the performance parameter set corresponding to each of the degradation failure components, the failure thresholds and the preset second cumulative failure probability distribution data.

The second cumulative failure probability distribution data refer to a distribution function configured to fit the second cumulative failure probabilities of the degradation failure components, such as a standard normal distribution function. The performance parameter value refers to the performance level or performance index value of a product or system under specific conditions. For example, for a mechanical bearing, its performance parameter value may be the rotational speed at a specific moment.

Following the above embodiment, taking m servo systems including m degenerate failure components B as an example, the failure threshold of the degenerate failure component B is Y, then based on the standard normal distribution function, the second cumulative failure probability function of the degenerate failure component B can be determined, which is expressed by formula (12):

$$F ( t ) = Φ \{ {( \frac{g}{Y} )}^{- \frac{1}{2}} [ {( \frac{thg}{Y} )}^{\frac{1}{2}} - {( \frac{Y}{thg} )}^{\frac{1}{2}} ] \} \qquad ( 12 )$$

where, Φ(□) is the standard normal distribution function, h and g are unknown parameters of the second cumulative failure probability function. The process of solving the above unknown parameters can be as follows.

When the accelerated degradation tests are performed on the m degradation failure components B, the performance parameter values of the degradation failure components B at a series of preset moments can be recorded. For example, assuming that the performance parameter values of the i-th degenerate failure component B in tᵢ₁,tᵢ₂, . . . ,tᵢⱼ, . . . ,tᵢₙ are Eᵢ₁,Eᵢ₂, . . . ,Eᵢⱼ, . . . ,Eᵢₙ, respectively, the performance degradation amount eᵢⱼ of the degenerate failure component B between tᵢ₍ⱼ₋₁₎ and tᵢⱼ can be expressed by formula (13):

$${e}_{ij} = {E}_{ij} - {E}_{i ( j - 1 )} . \qquad ( 13 )$$

According to formulas (12) and (13), a likelihood function of the performance parameters of the degraded failure component B can be expressed as formula (14):

$$W ( h , g ) = {\prod }_{i = 1}^{m} {\prod }_{j = 1}^{n} \{ \frac{( {e}_{ij} ) \hat{} [ h ( {t}_{ij} - {t}_{i ( j - 1 )} ) - 1 ]}{Γ [ h ( {t}_{ij} - {t}_{i ( j - 1 )} ) ] g \hat{} [ h ( {t}_{ij} - {t}_{i ( j - 1 )} ) ]} exp ( - \frac{{e}_{ij}}{g} ) \} \qquad ( 14 )$$

By solving the following set of formulas (15), the estimated values ĥ and ĝ of the unknown parameters h and g in the second cumulative failure probability function can be determined.

$$\{ \begin{matrix}\frac{dW ( h , g )}{dh} = \frac{d \{ {\prod }_{i = 1}^{m} {\prod }_{j = 1}^{n} \{ \frac{( {e}_{ij} ) \hat{} [ v ( {t}_{ij} - {t}_{i ( j - 1 )} ) - 1 ]}{Γ [ v ( {t}_{ij} - {t}_{i ( j - 1 )} ) ] u \hat{} [ v ( {t}_{ij} - {t}_{i ( j - 1 )} ) ]} exp ( - \frac{{e}_{ij}}{u} ) \} \}}{dh} = 0 \\ \frac{dW ( h , g )}{d g} = \frac{d \{ {\prod }_{i = 1}^{m} {\prod }_{j = 1}^{n} \{ \frac{( {e}_{ij} ) \hat{} [ v ( {t}_{ij} - {t}_{i ( j - 1 )} ) - 1 ]}{Γ [ v ( {t}_{ij} - {t}_{i ( j - 1 )} ) ] u \hat{} [ v ( {t}_{ij} - {t}_{i ( j - 1 )} ) ]} exp ( - \frac{{e}_{ij}}{u} ) \} \}}{d g} = 0\end{matrix} . \qquad ( 15 )$$

In formula (15), dW(h,g)/dh and dW(h,g)/dg are the derivatives of the function W(h,g) with respect to h and g, respectively.

According to formula (15) and formula (12), the second cumulative failure probability function of the degenerate failure component B can be determined, which is expressed by formula (16):

$$F ( t ) = Φ \{ {( \frac{\hat{g}}{Y} )}^{- \frac{1}{2}} [ {( \frac{t \hat{h} \hat{g}}{Y} )}^{\frac{1}{2}} - {( \frac{Y}{t \hat{h} \hat{g}} )}^{\frac{1}{2}} ] \} . \qquad ( 16 )$$

By adopting the same method as above, the second cumulative failure probability functions of the degradation failure components under the second preset accelerated stress can be determined as follows: F_{D1}(t),F_{D2}(t), . . . ,F_{DB}(t).

In this embodiment, the failure thresholds of the degradation failure components under the second preset accelerated stress and the performance parameter set at the preset time are fully considered. Combined with the normal distribution function, the second cumulative failure probability function of each of the degradation failure components is determined, which can rigorously and accurately represent the failure conditions of the degradation failure components at a specific time point or a specific time period, thereby accurately evaluating the reliability of the product.

In an embodiment, S800 includes: determining first failure times of the sudden failure components under a normal stress based on the first cumulative failure probability functions and first preset acceleration coefficients; determining second failure times of the degradation failure components under a normal stress based on the second cumulative failure probability functions and second preset acceleration coefficients. The target failure time of the product to be tested under a normal stress is determined based on the first failure times and the second failure times. The target failure time is configured to indicate the reliability of the product to be tested.

The acceleration coefficient is related to the acceleration stress, the first preset acceleration coefficient corresponds to the first preset acceleration stress, and the second preset acceleration coefficient corresponds to the second preset acceleration stress. Generally speaking, the greater the value of the acceleration stress, the more obvious the acceleration effect, and the greater the corresponding acceleration coefficient. In addition, the acceleration factor can be configured to represent the relationship between the failure conditions of a component under the normal stress and under accelerated stress, such as a ratio of the failure time under the normal stress to the failure time under accelerated stress.

Following the above embodiment, for the first cumulative failure probability functions of A sudden failure components, A random numbers can be randomly generated between 0 and 1, which are r_{S1},r_{S2}, . . . ,r_{SA} respectively. By solving the formula group shown in formula (17), the failure times t_{S1},t_{S2}, . . . ,t_{SA} of the sudden failure components under the first preset acceleration stress can be determined as follows:

$$\{ \begin{matrix}{F}_{S 1} ( {t}_{S 1} ) = 1 - exp [ - {( \frac{{t}_{S 1}}{{\hat{α}}_{S 1}} )}^{{\hat{β}}_{S 1}} ] = {r}_{S 1} \\ {F}_{S 2} ( {t}_{S 2} ) = 1 - exp [ - {( \frac{{t}_{S 2}}{{\hat{α}}_{S 2}} )}^{{\hat{β}}_{S 2}} ] = {r}_{S 2} \\ … \\ {F}_{SA} ( {t}_{SA} ) = 1 - exp [ - {( \frac{{t}_{SA}}{{\hat{α}}_{SA}} )}^{{\hat{β}}_{S 2}} ] = {r}_{SA}\end{matrix} . \qquad ( 17 )$$

In formula (17), F_{S1}(t_{S1}),F_{S2}(t_{S2}), . . . ,F_{SA}(t_{SA}) are the first cumulative failure probabilities corresponding to the failure times t_{S1},t_{S2}, . . . ,t_{SA} of the sudden failure components. \hat{α}_{S1},\hat{α}_{S2}, . . . ,\hat{α}_{SA} and \hat{β}_{S1},\hat{β}_{S2}, . . . ,\hat{β}_{SA} are the unknown parameter evaluation values corresponding to the first cumulative failure probability functions F_{S1}(t),F_{S2}(t), . . . ,F_{SA}(t) of the sudden failure components.

If the first acceleration coefficients of the above-mentioned sudden failure components are J_{S1},J_{S2}, . . . ,J_{SA}, respectively, then the first failure times of the sudden failure components under normal stress are t_{S1}J_{S1},t_{S2}J_{S2}, . . . ,t_{SA}J_{SA}, respectively.

For the second cumulative failure probability functions for the B degradation failure components, the failure times t_{D1},t_{D2}, . . . ,t_{DB} of the degradation failure components under the second preset accelerated stress can be determined by solving the formula group shown in formula (18) based on B randomly generated random numbers r_{D1},r_{D2}, . . . ,r_{DB} ranging from 0 to 1:

$$\{ \begin{matrix}{F}_{D 1} ( {t}_{D 1} ) = Φ \{ {( \frac{{\hat{g}}_{D 1}}{{Y}_{D 1}} )}^{- \frac{1}{2}} [ {( \frac{{t}_{D 1} {\hat{h}}_{D 1} {\hat{g}}_{D 1}}{{Y}_{D 1}} )}^{\frac{1}{2}} - {( \frac{{Y}_{D 1}}{{t}_{D 1} {\hat{h}}_{D 1} {\hat{g}}_{D 1}} )}^{\frac{1}{2}} ] \} = {r}_{D 1} \\ {F}_{D 2} ( {t}_{D 2} ) = Φ \{ {( \frac{{\hat{g}}_{D 2}}{{Y}_{D 2}} )}^{- \frac{1}{2}} [ {( \frac{{t}_{D 2} {\hat{h}}_{D 2} {\hat{g}}_{D 2}}{{Y}_{D 2}} )}^{\frac{1}{2}} - {( \frac{{Y}_{D 2}}{{t}_{D 2} {\hat{h}}_{D 2} {\hat{g}}_{D 2}} )}^{\frac{1}{2}} ] \} = {r}_{D 2} \\ … \\ {F}_{DA} ( {t}_{DB} ) = Φ \{ {( \frac{{\hat{g}}_{DB}}{{Y}_{DB}} )}^{- \frac{1}{2}} [ {( \frac{{t}_{DB} {\hat{h}}_{DB} {\hat{g}}_{DB}}{{Y}_{DB}} )}^{\frac{1}{2}} - {( \frac{{Y}_{DB}}{{t}_{DB} {\hat{h}}_{DB} {\hat{g}}_{DB}} )}^{\frac{1}{2}} ] \} = {r}_{DB}\end{matrix} . \qquad ( 18 )$$

In formula (18), F_{D1}(t_{D1}),F_{D2}(t_{D2}), . . . ,F_{DB}(t_{DB}) are the second cumulative failure probabilities corresponding to the failure times t_{D1},t_{D2}, . . . ,t_{DB} of the degradation failure components. ĥ_{D1},ĥ_{D2}, . . . ĥ_{DA} and ĝ_{D1},ĝ_{D2}, . . . ĝ_{DA} are the unknown parameter evaluation values corresponding to the second cumulative failure probability functions F_{D1}(t),F_{D2}(t), . . . ,F_{DB}(t) of the degradation failure components. Y_{D1},Y_{D2}, . . . ,Y_{DB} are the failure thresholds of the degradation failure components respectively.

If the second acceleration coefficients of the above-mentioned degradation failure components are J_{D1},J_{D2}, . . . ,J_{DB}, respectively, then the second failure times of the degradation failure components under normal use stress are t_{D1}J_{D1},t_{D2}J_{D2}, . . . ,t_{DB}J_{DB}, respectively.

Furthermore, according to the first failure times and the second failure times obtained in the above method, the target failure time t_{Z} of the product to be tested under the normal stress can be determined, and the calculation formula is as following formula (19):

$${t}_{Z} = min ( {t}_{S 1} {J}_{S 1} , {t}_{S 2} {J}_{S 2} , … , {t}_{SA} {J}_{SA} , {t}_{D 1} {J}_{D 1} , {t}_{D 2} {J}_{D 2} , … , {t}_{DB} {J}_{DB} ) . \qquad ( 19 )$$

The above target failure time t_{Z} can be used to indicate the reliability of the product to be tested.

In this embodiment, the failure times of the plurality of the sudden failure components and the plurality of the degradation failure components of the product to be tested under the normal stress are determined respectively. Based on the above failure times, the target failure time of the product to be tested under the normal stress are calculated to determine the reliability of the product. The above scheme is particularly suitable for products to be tested that include complex components. Since the failure modes of the various components are different, if only accelerated life tests or accelerated degradation tests are performed on the products to be tested, some components may be subjected to non-influencing stresses, resulting in inaccurate reliability evaluation results. The solution of this embodiment can effectively solve this technical problem.

In an embodiment, after determining the target failure time of the product to be tested under the normal stress based on the first failure times and the second failure times, the product testing method integrating accelerated life test and accelerated degradation test further includes: on a condition that there are a plurality of products to be tested, fitting a plurality of target failure times based on preset failure probability distribution data to obtain a cumulative failure probability function of the products to be tested, determining a mean time between failures of the products to be tested based on the cumulative failure probability function, and determining the reliability of the products to be tested based on the mean time between failures.

The mean time between failures (MTBF) refers to a ratio of an average operating time of a product or system to the number of failures within a specific period of time. The MTBF can be used to indicate the reliability of the system or product, and predict the failure rate or failure characteristics of the system or product.

In this embodiment, by repeating the step of determining the target failure time of the product to be tested in the above embodiment, a group of target failure times t_{Z1},t_{Z2}, . . . ,t_{Zk}, . . . ,t_{Zq} of the products to be tested can be obtained. Then, in the same way as in the accelerated life test embodiment, after constructing the cumulative failure probability function and evaluating the unknown parameters, the cumulative failure probability function of this group of products under the normal stress can be fitted, which can be expressed by formula (20):

$${F}_{Z} ( t ) = 1 - exp [ - {( \frac{t}{{\hat{α}}_{Z}} )}^{{\hat{β}}_{Z}} ] . \qquad ( 20 )$$

In formula (20), \hat{α}_{Z} and \hat{β}_{Z} are the estimated values of the unknown parameters of the cumulative failure probability function of the group of products under the normal stress. The method for evaluating the unknown parameters has been explained in the above embodiment and will not be repeated here. It can be understood that the products included in the group are identical.

Furthermore, after the cumulative failure probability function of the group of products under the normal stress are determined, the mean time between failures MTBF of this series of products can be calculated by formula (21):

$$MTBF = {\int }_{0}^{∞} [ 1 - {F}_{Z} ( t ) ] dt . \qquad ( 21 )$$

Based on the above-mentioned mean time between failures, the reliability of these products can be determined. For example, the shorter the mean time between failures, the more likely that type of product is to failure, and the lower the reliability. Conversely, the longer the mean time between failures, the higher the reliability.

Taking the servo system as an example, according to the above methods, the cumulative failure probability of the servo system under the normal stress is as shown in formula (22):

$${F}_{Z} ( t ) = 1 - exp [ - {( \frac{t}{3.56 \times 1 {0}^{4}} )}^{2.15} ] . \qquad ( 22 )$$

Then, according to formula (21), the mean time between failures of the servo system is obtained as shown in formula (23):

$$MTBF = {\int }_{0}^{∞} [ 1 - {F}_{Z} ( t ) ] dt = 3.15 \times 1 {0}^{4} h . \qquad ( 23 )$$

In this embodiment, the mean time between failures of the product can be determined based on the cumulative failure probability function of a group of products to be tested, and the reliability of the product to be tested can be measured based on this reliability index, which can make the test results more accurate and reliable and the test efficiency higher.

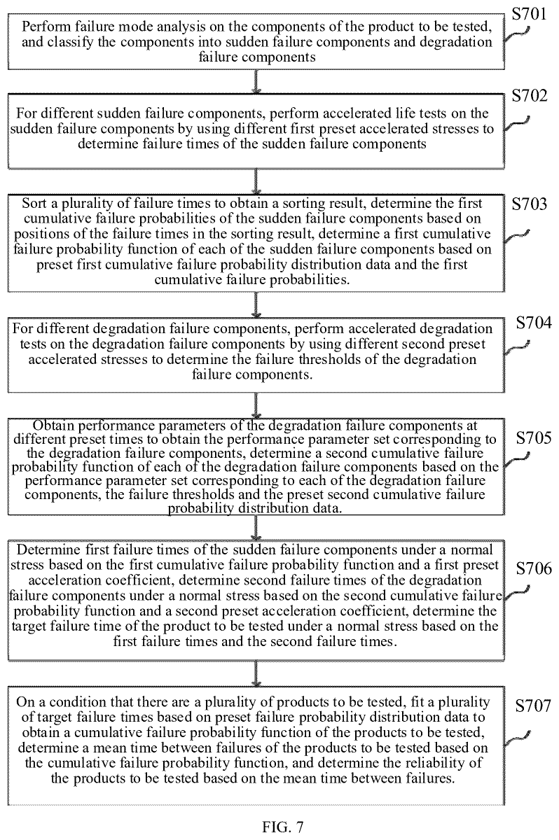

In order to make a clearer description of the product testing method integrating accelerated life test and accelerated degradation test provided by the present disclosure, the following description is made in conjunction with a specific embodiment and FIG. 7. The specific embodiment includes the following steps.

In S701, failure mode analysis is performed on the components of the product to be tested, and the components are classified into sudden failure components and degradation failure components.

In S702, for different sudden failure components, accelerated life tests are performed on the sudden failure components by using different first preset accelerated stresses to determine failure times of the sudden failure components.

In S703, a plurality of failure times are sorted to obtain a sorting result. The first cumulative failure probabilities of the sudden failure components are determined based on positions of the failure times in the sorting result. A first cumulative failure probability function of the sudden failure components is determined based on preset first cumulative failure probability distribution data and the first cumulative failure probabilities.

In S704, for different degradation failure components, accelerated degradation tests are performed on the degradation failure components by using different second preset accelerated stresses to determine the failure thresholds of the degradation failure components.

In S705, performance parameters of the degradation failure components at different preset times are obtained to obtain the performance parameter set corresponding to the degradation failure components. A second cumulative failure probability function of each of the degradation failure components is determined based on the performance parameter set corresponding to each of the degradation failure components, the failure thresholds and the preset second cumulative failure probability distribution data.

In S706, first failure times of the sudden failure components under a normal stress are determined based on the first cumulative failure probability function and a first preset acceleration coefficient. Second failure times of the degradation failure components under a normal stress are determined based on the second cumulative failure probability function and a second preset acceleration coefficient. The target failure time of the product to be tested under a normal stress is determined based on the first failure times and the second failure times.

In S707, on a condition that there are a plurality of products to be tested, a plurality of target failure times are fitted based on preset failure probability distribution data to obtain a cumulative failure probability function of the products to be tested, a mean time between failures of the product to be tested is determined based on the cumulative failure probability function, and the reliability of the product to be tested is determined based on the mean time between failures.

It should be understood that, although the steps in the flowcharts involved in the embodiments described above are displayed sequentially as indicated by the arrows, these steps are not necessarily executed sequentially in the order indicated by the arrows. Unless otherwise specified herein, there is no strict order restriction on the execution of these steps, and these steps may be executed in other sequences. Moreover, at least a part of the steps in the flowcharts involved in the embodiments described above may include multiple steps or multiple stages. These steps or stages are not necessarily executed at the same time, but can be executed at different times. The execution order of these steps or stages is not necessarily sequential, but can be executed in turn or alternately with other steps or at least part of the steps or stages in other steps.

Based on the same inventive concept, an embodiment of the present disclosure also provides a product testing apparatus integrating accelerated life test and accelerated degradation test, which is used to implement the above-mentioned product testing method integrating accelerated life test and accelerated degradation test. The solution to the problem provided by the apparatus is similar to the solution described in the above method. Therefore, the specific limitations in one or more embodiments of the product testing apparatus integrating accelerated life test and accelerated degradation test provided below can be referred to the limitations on the above-mentioned product testing method integrating accelerated life test and accelerated degradation test, and will not be repeated here.

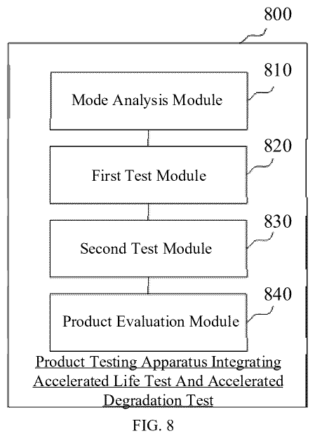

In an embodiment, as shown in FIG. 8, the product testing apparatus 800 integrating accelerated life test and accelerated degradation test is provided. The apparatus 800 includes a mode analysis module 810, a first test module 820, a second test module 830, and a product evaluation module 840.

The mode analysis module 810 is configured to perform failure mode analysis on components of the product to be tested, and classify the components into sudden failure components and degradation failure components.

The first test module 820 is configured to perform accelerated life tests on the sudden failure components to determine a first cumulative failure probability function of each of the sudden failure components.

The second test module 830 is configured to perform accelerated degradation tests on the degradation failure components to determine a second cumulative failure probability function of each of the degradation failure components.

The product evaluation module 840 is configured to determine a reliability of the product to be tested based on the first cumulative failure probability function and the second cumulative failure probability function.

Each module in the above-mentioned product testing apparatus integrating accelerated life test and accelerated degradation test can be fully or partially implemented through software, hardware and a combination thereof. The above modules may be embedded in or independent of a processor in a computer device in the form of hardware, or may be stored in a memory in a computer device in the form of software, so that the processor can call and execute operations corresponding to the above modules.

In an embodiment, there are a plurality of sudden failure components, and the first test module 820 is further configured to perform accelerated life tests on the sudden failure components by using different first preset accelerated stresses for different sudden failure components, to determine failure times of the sudden failure components, and determine a first cumulative failure probability function of the sudden failure components based on the failure times of the sudden failure components.

In an embodiment, the first test module 820 is further configured to sort a plurality of failure times to obtain a sorting result, determine the first cumulative failure probability of each of the sudden failure components based on the position of each of the failure times in the sorting result, and determine the first cumulative failure probability function of each of the sudden failure components based on preset first cumulative failure probability distribution data and the first cumulative failure probabilities.

In an embodiment, there are a plurality of degradation failure components, and the second test module 830 is further configured to perform accelerated degradation tests on degradation failure components by using different second preset accelerated stresses for different degradation failure components, to determine the failure thresholds of the degradation failure components, and determine the second cumulative failure probability function of the degradation failure components based on the failure thresholds of the degradation failure components.

In an embodiment, the second test module 830 is further configured to obtain the performance parameters of the degradation failure components at different preset times to obtain the performance parameter set corresponding to the degradation failure components, and determine a second cumulative failure probability function of each of the degradation failure components based on the performance parameter set corresponding to each of the degradation failure components, the failure thresholds and the preset second cumulative failure probability distribution data.

In an embodiment, the product evaluation module 840 is further configured to determine first failure times of the sudden failure components under a normal stress based on a first cumulative failure probability function and a first preset acceleration coefficient, determine second failure times of a degenerate failure components under a normal stress based on the second cumulative failure probability function and a second preset acceleration coefficient, and determine a target failure time of the product to be tested under a normal stress based on the first failure times and the second failure times. The target failure times is configured to indicate a reliability of the product to be tested.

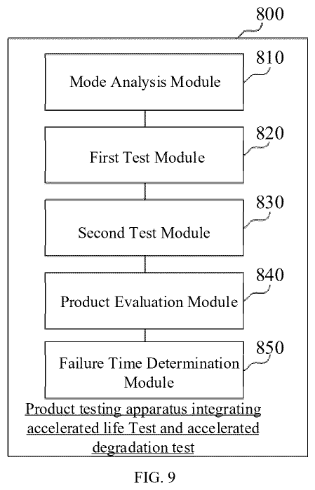

In an embodiment, as shown in FIG. 9, the product testing apparatus integrating accelerated life test and accelerated degradation test further includes a failure time determination module 850, which is configured to, on a condition that there are a plurality of products to be tested, fit a plurality of target failure times based on preset failure probability distribution data to obtain a cumulative failure probability function of the product to be tested, determine the mean time between failures of the product to be tested based on the cumulative failure probability function, and determine the reliability of the product to be tested based on the mean time between failures.

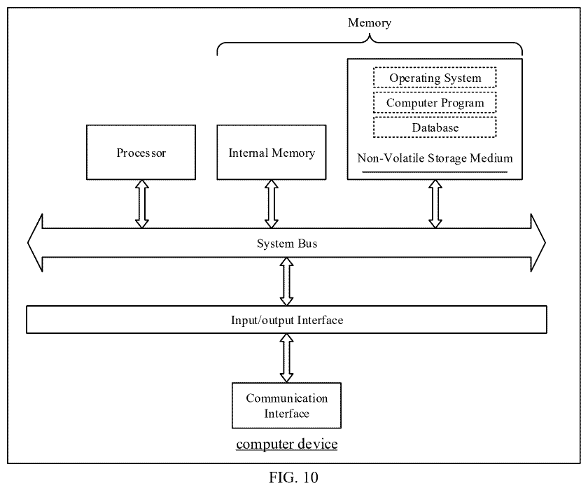

In an embodiment, a computer device is provided. The computer device may be a server, and its schematic diagram of an internal configuration may be as shown in FIG. 10. The computer device includes a processor, a memory, an input/output interface (I/O for short) and a communication interface. The processor, the memory and the input/output interface are connected via a system bus, and the communication interface is connected to the system bus via the input/output interface. The processor of the computer device is configured to provide computing and control capabilities. The memory of the computer device includes a non-volatile storage medium and an internal memory. The non-volatile storage medium stores an operating system, a computer program, and a database. The internal memory provides an environment for the operation of the operating system and computer programs in the non-volatile storage medium. The database of the computer device is configured to store data such as the first cumulative failure probability function and the second cumulative failure probability function. The input/output interface of the computer device is configured to exchange information between the processor and external devices. The communication interface of the computer device is configured to communicate with an external terminal via a network connection. A processor, when executing the computer program, implements the steps of the method for comprehensive product testing of integrating accelerated life and accelerated degradation.

Those skilled in the art will understand that the structure shown in FIG. 10 is merely a block diagram of a partial structure related to the solution of the present disclosure, and does not constitute a limitation on the computer device to which the solution of the present disclosure is applied. The specific computer device may include more or fewer components than shown in the figure, or combine certain components, or have a different arrangement of components.

In an embodiment, a computer device is provided, including a memory and a processor. A computer program is stored in the memory. The processor, when executing the computer program, implements the steps of the product testing method integrating accelerated life test and accelerated degradation test in the above-mentioned embodiments.

In an embodiment, a computer-readable storage medium is provided, on which a computer program is stored. A processor, when executing the computer program, implements the steps of the product testing method integrating accelerated life test and accelerated degradation test in the above-mentioned embodiments.

In an embodiment, a computer program product is provided, including a computer program. A processor, when executing the computer program, implements the steps of the product testing method integrating accelerated life test and accelerated degradation test in the above-mentioned embodiments.

It should be noted that the user information (including but not limited to user device information, user personal information, etc.) and data (including but not limited to data used for analysis, stored data, displayed data, etc.) involved in the present disclosure are those authorized by the user or sufficiently authorized by the parties. The collection, use and processing of the relevant data need to comply with the relevant laws, regulations and standards of the relevant countries and regions.

Those of ordinary skill in the art can understand that all or part of the processes in the methods of the above embodiments can be completed by instructing relevant hardware through a computer program. The computer program can be stored in a non-volatile computer-readable storage medium. The computer program, when executed, may include processes such as those of the embodiments of the methods described above. Any reference to memory, database or other media used in the embodiments provided in the present disclosure may include at least one of non-volatile and volatile memory. Non-volatile memory can include read-only memory (ROM), magnetic tape, floppy disk, flash memory, optical memory, high-density embedded non-volatile memory, resistive memory (ReRAM), Magnetoresistive Random Access Memory (MRAM), Ferroelectric Random Access Memory (FRAM), Phase Change Memory (PCM), graphene memory, etc. Volatile memory may include Random Access Memory (RAM) or external cache memory, etc. By way of illustration and not limitation, RAM can be in many forms, such as Static Random Access Memory (SRAM) or Dynamic Random Access Memory (DRAM). The databases involved in the various embodiments provided in the present disclosure may include at least one of a relational database and a non-relational database. Non-relational databases may include blockchain-based distributed databases, etc., but are not limited thereto. The processors involved in the various embodiments provided in the present disclosure may be general-purpose processors, central processing units, graphics processors, digital signal processors, programmable logic devices, quantum computing-based data processing logic devices, etc., and are not limited to this.

The technical features of the above embodiments can be randomly combined. To simplify the description, not all possible combinations of the technical features in the above embodiments are described. However, as long as there is no contradiction in the combination of these technical features, all the combinations should be considered to be included within the scope of this specification.

5 The above-described embodiments only illustrate several embodiments of the present disclosure, and the descriptions of which are relatively specific and detailed, but should not be construed as limiting the scope of the patent disclosure. It should be noted that, for those of ordinary skill in the art, several modifications and improvements can be made without departing from the concept of the present disclosure, and these all fall within 10 the protection scope of the present disclosure. Therefore, the protection scope of the present disclosure should be determined by the appended claims.

1. An integrated product testing method for products combining accelerated life test and accelerated degradation test applied to a testing system, wherein the method comprises:
performing failure mode analysis on components of a product to be evaluated, and classifying the components into sudden failure components and degradation failure components;
for different sudden failure components, performing accelerated life tests on the sudden failure components by using different first preset accelerated stresses to determine failure times of the sudden failure components, determining first cumulative failure probabilities of the sudden failure components based on the failure times, and determining a first cumulative failure probability function of each of the sudden failure components based on the first cumulative failure probabilities and preset first cumulative failure probability distribution data;
for different degradation failure components, performing accelerated degradation tests on the degradation failure components by using different second preset accelerated stresses to determine failure thresholds of the degradation failure components, obtaining performance parameters of each of the degradation failure components at different preset moments to obtain performance parameter set corresponding to each of the degradation failure components, and determining a second cumulative failure probability function of each of the degradation failure components based on the performance parameter set corresponding to each of the degradation failure components, the failure thresholds and preset second cumulative failure probability distribution data; and
determining first failure times of the sudden failure components under a normal stress based on the first cumulative failure probability function and a first preset acceleration coefficient, determining second failure times of the degradation failure components under a normal stress based on the second cumulative failure probability function and a second preset acceleration coefficient, determining a target failure time of the product to be evaluated under a normal stress based on the first failure times and the second failure times, and determining a reliability of the product to be evaluated based on the target failure time.

2. The method according to claim 1, wherein determining the first cumulative failure probabilities of the sudden failure components based on the failure times comprises:
sorting the failure times to obtain a sorting result; and
determining the first cumulative failure probabilities of the sudden failure components based on positions of the failure times in the sorting result.

3. The method according to claim 1, wherein after determining the target failure time of the product to be evaluated under the normal stress based on the first failure times and the second failure times, the method further comprises:
on a condition that there are a plurality of the products to be evaluated, fitting the target failure times based on preset failure probability distribution data to obtain a cumulative failure probability function of the products to be evaluated;
determining a mean time between failures of the products to be evaluated based on the cumulative failure probability function; and
determining the reliability of the products to be evaluated based on the mean time between failures.

4. The method according to claim 1, wherein the preset first cumulative failure probability distribution data comprise a Weibull distribution function, an exponential distribution function, or a log-normal distribution function, and
the preset second cumulative failure probability distribution data comprise a standard normal distribution function.

5. An integrated product testing apparatus combining accelerated life test and accelerated degradation test, wherein the apparatus comprises:
a mode analysis module configured to perform failure mode analysis on components of the product to be evaluated, and classify the components into sudden failure components and degradation failure components;
a first test module configured to perform accelerated life tests on the sudden failure components by using different first preset accelerated stresses for different sudden failure components, to determine failure times of the sudden failure components, determine first cumulative failure probabilities of the sudden failure components based on the failure times, and determine a first cumulative failure probability function of each of the sudden failure components based on the first cumulative failure probabilities and preset first cumulative failure probability distribution data;
a second test module configured to perform accelerated degradation tests on the degradation failure components by using different second preset accelerated stresses for different degradation failure components, to determine failure thresholds of the degradation failure components, obtain performance parameters of each of the degradation failure components at different preset moments to obtain performance parameter set corresponding to each of the degradation failure components, and determine a second cumulative failure probability function of each of the degradation failure components based on the performance parameter set corresponding to each of the degradation failure components, the failure thresholds and the preset second cumulative failure probability distribution data; and
a product evaluation module configured to determine first failure times of the sudden failure components under a normal stress based on the first cumulative failure probability function and a first preset acceleration coefficient, determine second failure times of the degradation failure components under a normal stress based on the second cumulative failure probability function and a second preset acceleration coefficient, determine a target failure time of the product to be evaluated under a normal stress based on the first failure times and the second failure times, and determine a reliability of the product to be evaluated based on the target failure time.

6. The apparatus according to claim 5, wherein the first test module is further configured to sort the failure times to obtain a sorting result, and determine the first cumulative failure probabilities of the sudden failure components based on positions of the failure times in the sorting result.

7. The apparatus according to claim 5, wherein the preset first cumulative failure probability distribution data comprise a Weibull distribution function, an exponential distribution function, or a log-normal distribution function; and
the preset second cumulative failure probability distribution data comprise a standard normal distribution function.

8. The apparatus according to claim 5, wherein the apparatus further comprises a failure time determination module configured to, on a condition that there are a plurality of the products to be evaluated, fit the target failure times based on preset failure probability distribution data to obtain a cumulative failure probability function of the products to be evaluated, determine a mean time between failures of the products to be evaluated based on the cumulative failure probability function, and determine the reliability of the products to be evaluated based on the mean time between failures.

9. A computer device comprising a memory and a processor, the memory storing a computer program, wherein the processor, when executing the computer program, implements the steps of the method of claim 1.

10. A non-transitory computer-readable storage medium having a computer program stored thereon, wherein a processor, when executing the computer program, implements the steps of the method of claim 1.
